(19) United States
(12) Patent Application Publication
(10) Pub. No.: US 2022/0219989 A1
(43) Pub. Date: Jul. 14, 2022

(54) HIGH TEMPERATURE CARBON BLACK AIR PREHEATER

(71) Applicant: BIRLA CARBON U.S.A., INC., MARIETTA, GA (US)

(72) Inventor: CHARLES SCHENCK WILEY, MARIETTA, GA (US)

(73) Assignee: BIRLA CARBON U.S.A., INC., MARIETTA, GA (US)

(21) Appl. No.: 17/616,493

(22) PCT Filed: Jun. 5, 2020
(86) PCT No.: PCT/US20/36484

§ 371 Date: Dec. 3, 2021

Related U.S. Application Data
(60) Provisional application No. 62/857,776, filed on Jun. 5, 2019.

(51) Int. Cl. C01B 32/05; C22C 38/52; C22C 38/44; C22C 38/02; C22C 38/04; C22C 38/06

(52) U.S. Cl. CPC C01B 32/05; C22C 38/52; C22C 38/06; C22C 38/02; C22C 38/04; C22C 38/44

(57) ABSTRACT

High temperature carbon black air preheater and materials useful in the design and construction thereof.

### BACKGROUND

### Technical Field

The present disclosure relates to high temperature air preheater technology that can be useful in the manufacture, handling, and/or post-treatment of carbon black and other particular carbonaceous materials.

### Technical Background

Carbon black manufacturing processes can involve high temperatures and environments that can result in the degradation of may common industrial materials. Thus, there is a need for improved materials for use in carbon black manufacturing, handling, and post-treatment processes. These needs and other needs are satisfied by the compositions and methods of the present disclosure.

### SUMMARY

In accordance with the purpose(s) of the invention, as embodied and broadly described herein, this disclosure, in one aspect, relates to high temperature materials and air preheaters comprising the same, suitable for use in, for example, carbon black manufacturing, handling, and/or post-processing; together with articles and methods of manufacturing and using the above.

In one aspect, the present disclosure provides a carbon black air preheater, wherein at least a portion of the carbon black air preheater comprises an alloy comprising from about 3 wt. % to about 10 wt. % aluminum, from about 18 wt. % to about 28 wt. % chromium, from about 0 wt. % to about 0.1 wt. % carbon, from about 0 wt. % to about 3 wt. % silicon, from about 0 wt. % to about 0.4 wt. % manganese, from about 0 wt. % to about 0.5 wt. % molybdenum, from about 0 wt. % to about 37 wt. % nickel, from about 0 wt. % to about 29 wt. % cobalt, and a remaining balance of iron.

In another aspect, the present disclosure provides a carbon black air preheater comprising an alloy that forms a surface passivating layer on at least a portion of the alloy upon sustained exposure to a carbon black manufacturing environment.

In another aspect, the present disclosure provides a carbon black air preheater wherein all or a portion of a plurality of tubes disposed within the carbon black air preheater comprise an alloy, as described herein.

In another aspect, the present disclosure provides a carbon black air preheater capable of heating air to a temperature of at least about 1,000° C. for a sustained period of time.

In yet another aspect, the present disclosure provides a carbon black manufacturing process comprising a carbon black furnace and a carbon black air preheater positioned downstream of and in fluid communication with the carbon black furnace, wherein the carbon black air preheater comprises an alloy comprising from about 3 wt. % to about 10 wt. % aluminum, from about 18 wt. % to about 28 wt. % chromium, from about 0 wt. % to about 0.1 wt. % carbon, from about 0 wt. % to about 3 wt. % silicon, from about 0 wt. % to about 0.4 wt. % manganese, from about 0 wt. % to about 0.5 wt. % molybdenum, and a remaining balance of iron.

### BRIEF DESCRIPTION OF THE DRAWINGS

The accompanying figures, which are incorporated in and constitute a part of this specification, illustrate several aspects and together with the description serve to explain the principles of the invention.

FIG. 1 is a schematic illustration of a conventional carbon black manufacturing process.

FIG. 2 is a cross-sectional illustration of a carbon black air preheater, in accordance with various aspects of the present disclosure.

FIG. 3 is an expended cross-sectional illustration of a carbon black air preheater, in accordance with various aspects of the present disclosure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless indicated otherwise, parts are parts by weight, temperature is in ° C. or is at ambient temperature, and pressure is at or near atmospheric.

As briefly described above, the present disclosure provides high temperature materials, high temperature air preheaters, and methods for the manufacture and use of the same, and in particular, in carbon black manufacturing processes.

### Carbon Black Manufacture

In one aspect, carbon black is a finely divided form of carbon produced by the incomplete combustion of heavy oil, such as FCC decant oil, coal tar, and/or ethylene cracking tar; these may commonly be referred to as carbon black feedstock. The conventional carbon black manufacturing process is often referred to as a furnace process, but variations and other manufacturing processes exist for certain types of carbon black.

In one aspect, the carbon black manufacturing process of the present disclosure can comprise any conventional process for preparing carbon black. In another aspect, such process can comprise a furnace process. In other aspects, the carbon black manufacturing process can comprise all of, a portion of, and/or variations of the method and apparatus in one or more of U.S. Patent Publication Nos. 2004/0241081 and 2004/0071626, and U.S. Pat. Nos. 4,391,789, 4,755,371, 5,009854, and 5,069882, each of which are incorporated herein by reference in their entirety for the purpose of disclosing carbon black manufacturing methods and apparatus.

Various methods for the production of carbon black are known in the art. Generally, the production of carbon black is performed in a reactor by partial combustion and/or pyrolytic conversion of hydrocarbons. In this conventional reactor process for manufacturing carbon black, a hydrocarbon fuel, commonly natural gas or fuel oil, is burned in a stream of process air furnished by a blower. The hot gases produced by the combustion of the fuel flow through a vessel, usually lined with refractory, and ordinarily of circular cross section. A feedstock oil, usually highly aromatic, which serves as the chief source of carbon in the system, is injected into the flowing hot gases downstream of a point where the combustion of the fuel is complete. The oil feedstock is typically vaporized as one step in the carbon black forming process. Vaporization is favored by high velocity of the hot gas stream, a high degree of turbulence, high temperature, and high degree of atomization of the oil.

The feedstock oil vapor is carried by the hot combustion gases, the combustion gases attaining temperatures of from about 2,400° F. to about 3,400° F., varying with the methods used for controlling combustion. Radiant heat from the refractory, heat directly transmitted by the hot gases, high shear and mixing in the hot gases, and combustion of a portion of the oil by residual oxygen in the combustion products all combine to transfer heat very rapidly to the feedstock oil vapors. Under these conditions, the oil feedstock molecules are cracked, polymerized and dehydrogenated, and progressively become larger and less hydrogenated until some reach a state such that they may be called nuclei of carbon. The nuclei grow in size, and at some stage there is coalescence of particles to form cluster-like aggregates. At the completion of the process, the hot gases containing the carbon black are quenched to a temperature low enough to stop or significantly slow the reactions, and to allow the carbon black to be collected by conventional means.

A broad variety of carbon blacks has been disclosed in the art. These carbon blacks differ in many properties from each other and are made by different processes. The main field of use of the blacks depends upon their properties. Since the carbon black, as such, cannot be sufficiently characterized by its chemical composition or by its ingredients, it has become widely accepted to characterize the carbon black by the properties it exhibits. Thus, the carbon black can, for example, be characterized by its surface area.

Carbon black is well known as a reinforcing agent for rubber to be used, for example, in compounds for the construction of tires. There are two general categories of carbon black used in the automotive tire industry. Certain types of carbon black are best used as reinforcing agents for tire tread compounds and other types of carbon black are best used for reinforcing agents in tire carcasses.

Tread type carbon blacks are usually produced by using a different process and reactor than that used for the production of carcass type carbon blacks. Tread blacks are small particle size. This requires a fast, hot reactor, i.e., higher velocity and temperature. Residence times for these processes are in the milliseconds order of magnitude. Tread blacks are made at higher velocities and lower ratios of oil to flowing gases than the carcass blacks.

Carcass type blacks comprise larger particles. In order for the particles to become large, the reaction is slow and done in a relatively low temperature reactor. Residence times are in the seconds order of magnitude. These carbon blacks are made at low velocities and high ratios of oil to flowing gases.

Typical carbon black reactors are disclosed in U.S. Pat. Nos. 4,822,588 and 4,824,643, which are also incorporated herein by reference in their entirety, wherein the reactors comprise a converging zone, a throat, a first reaction zone, and a second reaction zone serially connected. The reactor has a reaction flow passage having a longitudinal axis. The combustion zone and a reactor throat are positioned along the longitudinal axis of the reactor, and a converging zone converges from the combustion zone to the reactor throat. A quench zone is spaced apart from the reactor throat and has a cross sectional dimension generally larger than the cross sectional dimension of the reactor throat. A reaction zone connects the reactor throat with the quench zone. The reaction zone frequently has a cross sectional dimension less than that of the quench zone, and a length generally in the range of from 2 to 6 throat diameters. A burner is operably associated with the combustion zone to cause axial flow of hot combustion gases from the combustion zone to quench zone. At least one port for receiving an oil injector for introducing a carbonaceous feedstock radially inwardly toward the longitudinal axis of the reaction flow passage is provided in the reaction zone. The reactor is further provided with a means for introducing quench fluid into the quench zone. By providing oil injectors in the ports of both sides of the reactor throat, carbon black can be produced at high efficiencies.

Exemplary carbon black reactors, such as those described in the patents referenced above, comprise an upstream end, a converging zone, a reactor throat, a reaction zone, a quench zone, and a downstream end, and can be used to manufacture carbon black materials with a process comprising: (a) combusting a hydrocarbon fuel with excess amounts of oxygen-containing gas to form a mass of hot combustion gases containing free oxygen and flowing generally axially from the upstream end toward the downstream end of the reaction flow passage; (b) flowing the mass of hot combustion gases through the converging zone; (c) introducing a carbonaceous feedstock generally radially inwardly into the hot combustion gases at a position from the periphery of the converging zone to form a first reaction mixture; (d) flowing the first reaction mixture through the reactor throat, wherein the reactor throat has a radius and a diameter of two times the radius, past a first abrupt expansion in the reaction flow passage at a downstream end of the reactor throat, and into an upstream end of the reaction zone, said first abrupt expansion connecting the reactor throat with the reaction zone; (e) introducing additional carbonaceous feedstock generally radially inwardly into the reaction mixture at a position from the periphery of the reaction zone to form a second reaction mixture; and (f) flowing the second reaction mixture past a second abrupt expansion in the reaction flow passage at a downstream end of the reaction zone and into a quench zone having a sufficiently large diameter and length to provide for the formation of carbon black.

Such an exemplary reactor can have feedstock oil sprays located only downstream of the combustion zone of the reactor. The feedstock injectors are in the converging zone and in the reaction zone.

In another exemplary aspect, the carbon black reactor can comprise a combination combustion/reaction section that provides the desirable reaction volume for carcass carbon black types and combustion volume for tread carbon black types.

In a conventional carbon black manufacturing process, the smoke stream containing produced carbon black can be passed through a heat exchanger to cool the smoke stream and pre-heat combustion gasses to be used in the reactor. The smoke stream can also be filtered and densified to collect the carbon black. The resulting carbon black can further be formed into beads or pellets, and then optionally be subjected to a drying step. In such a process, the combustion gases can be recirculated into the reactor, cooled, or used for fuel value.

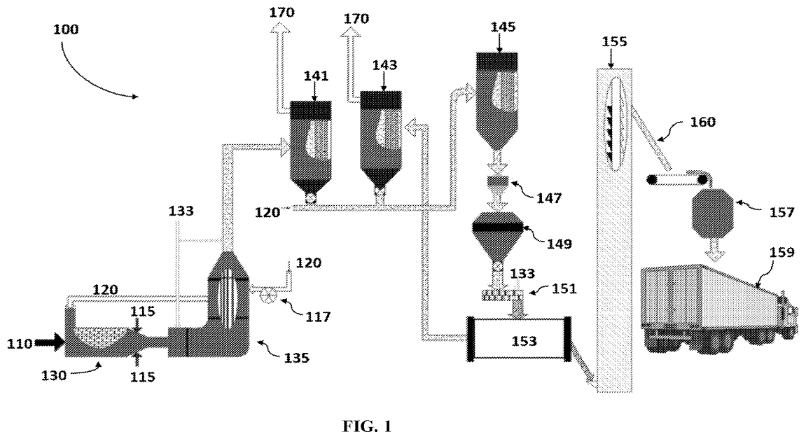

In one aspect, an exemplary carbon black manufacturing process 100 is illustrated in FIG. 1, wherein fuel oil and/or natural gas 110 and air 120 are introduced into a carbon black reactor furnace 130. All or a portion of the air can be introduced via a fan 117 and optionally passed through a heat exchanger 135 to raise the temperature of the air. Carbon black feedstock 115 can then be introduced where it is partially combusted to form carbon black particles. These particles can grow until the reaction is quenched via the introduction of water 135. The resulting smoke stream comprising carbon black, moisture, and unutilized carbon black feedstock can then be passed through the heat exchanger 135 and subjected to one or more initial processing steps, which can comprise separating the carbon black from the unutilized carbon black feedstock 170, sometimes referred to as tailgas. These initial processing steps can include the use of a main bag collector 141 and a secondary bag collector 145. The collected carbon black can then be passed through a pulverizer 147 to break up large agglomerates, and then to a densification tank 149 to increase the bulk density of the fluffy carbon black powder. In some cases, it can be desirable to package and transport carbon black in a beaded form instead of a powder form. In such cases, the carbon black can then be fed through a pin mixer 151, where water 135 and/or beading agents are introduced. The carbon black can then be fed through a dryer 153 to remove all or a portion of the moisture in the carbon black. Vapor from the dryer, which can contain carbon black, can also be recirculated to a vapor bag collector 143 for separation. In this exemplary aspect, the resulting carbon black 160 can be transported via, for example, an elevator 155 to a storage tank 157 and ultimately to a transportation means 159, such as a truck or railcar. It should be understood that the carbon black manufacturing process illustrated in FIG. 1 is intended to be exemplary in nature, and the current disclosure is not intended to be limited to this exemplary aspect.

One of skill in the art would be able to determine appropriate carbon black manufacturing methods and equipment, and the present disclosure is not intended to be limited to any particular carbon black manufacturing method or apparatus.

The environment in a carbon black manufacturing process can be particularly corrosive to, for example, metals used in the reactor and handling portions of the manufacturing process. In various aspects, the environment can comprise moisture, sulfur, and a mixture of gases, such as hydrogen and nitrogen. In various aspects, traditional alloys and even other alloys that claim to be suitable for use at elevated temperatures, can be subject to sulfidation, carburization, and/or oxidation upon exposure to the carbon black manufacturing environment. In one aspect, as used herein, sustained exposure to a carbon black manufacturing environment is intended to mean a period of about 3 to 4 weeks or more in the operating environment of a carbon black manufacturing process.

The air preheater of a carbon black manufacturing process can comprise any design or type suitable for use in such a process. In one aspect, a carbon black air preheater can be a recuperator. In another aspect, a carbon black air preheater can be a counter flow energy recovery heat exchanger. In yet another aspect, a carbon black air preheater can comprise a plurality of tubes arranged, for example, in parallel with each other. In various aspects, such tubes can be positioned in one or more rows or in a staggered arrangement. In still another aspect, the tubes can be disposed within an external shell. In still another aspect, the tubes can carry a first fluid in one direction, wherein a second fluid can flow outside the tubes and within an external shell in an opposing direction. In another aspect, one of more tubes can be arranged such that the longitudinal axis of each tube is parallel to the longitudinal axis of the air preheater. In a specific aspect, one end of the air preheater is in fluid communication with the carbon black reactor, such that the smoke stream containing carbon black and hot combustion gases are in contact. In such an aspect, the end of the air preheater in contact or in fluid communication with gases coming from the carbon black reactor can experience higher temperatures that other portions of the air preheater.

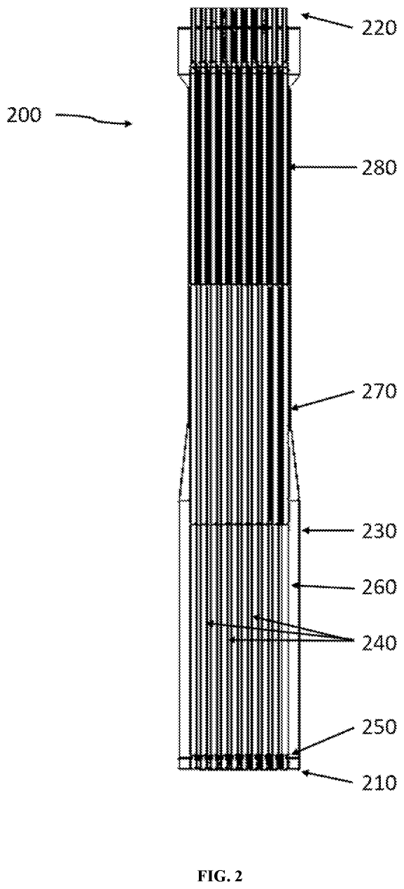

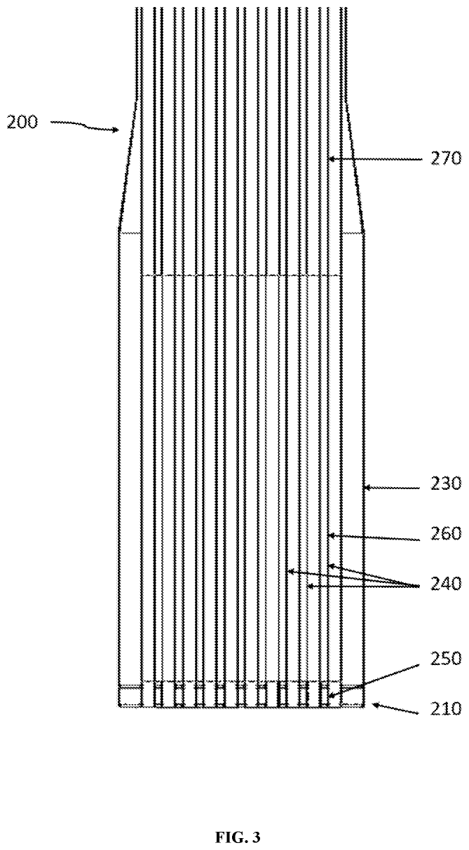

FIGS. 2 and 3 illustrate a schematic of an exemplary carbon black air preheater 200, having a first end 210 that can be in fluid communication with a carbon black reactor, and a second end 220 that can be in fluid communication with the conveying, handling, and collection portions of a carbon black manufacturing process. In one exemplary aspect, the first end can be exposed to significantly higher temperatures than the second end during operation as the hot gases and carbon black smoke stream exit the reactor. The exemplary air preheater comprises an external shell 230 and a plurality of tubes 240 disposed within the external shell 230. Within the external shell, a first fluid can be conducted via the tubes from the first end to the second end, where a second fluid can flow around the tubes, for example, in an opposing direction. Each of the plurality of tubes can comprise one or more sections comprising the same or different metals or alloys. In an exemplary aspect, a tube can comprise four sections, each comprises of a different material of construction, from the first end to the second end of the air preheater. In such an aspect, a first portion 250 in the area exposed to the highest temperatures during operation and in connection with the first end 210, a second portion 260, a third portion 270, and a fourth portion 280. The number of sections and materials of construction of any given tube can vary, and one of skill in the art could readily select an appropriate number of tubes, number of sections per tube, and materials for each tube and/or section.

Disclosed herein are various embodiments of an invention related to the design of a carbon black heat exchanger, also referred to as an air preheater, capable of operating temperatures beyond current state-of-the-art air preheat technology. The metal alloys selected for construction of a carbon black air preheater can determine the maximum use temperatures, which in turn can determine the maximum energy recovery possible with the device. Carbon black production rate and yield are generally known in the industry to increase with increasing air preheat temperature; therefore, there is considerable efficiency and financial benefit to an air preheater design that can operate at temperatures in excess of those currently availableCurrent air preheaters are typically limited to 950° C. air preheat temperatures largely in part due to the alloys out of which they are constructed. This invention teaches that the use of ferritic stainless steel alloys containing a ceramic oxide grain growth inhibitor, as well as aluminum, can result in a robust tube material that is capable resisting the highly corrosive gases within a carbon black process gas stream, as well as capable of operating for extended periods of time at temperatures that are −200° C. higher than alloys used in current state-of-the-art carbon black air preheaters, In one aspect, such alloys can comprise commercially available KANTHAL APM® and KANTHAL APMT® ferritic stainless steel alloys (available from Sandvik).

In various aspects, the alloy for use in at least part of the carbon black air preheater can comprise from about 5 wt. % to about 6 wt. %, for example, about 5, 5.2, 5.4, 5.6, 5.8, or 6 wt. %; from about 4 wt. % to about 6 wt. %, for example, about 4, 4.2, 4.4, 4.6, 4.8, 5, 5.2, 5.4, 5.6, 5.8, or 6 wt. %; or from about 3 wt. % to about 10 wt. %, for example, about 3, 3.1, 3.3, 3.5, 3.7, 3.9, 4, 4.1, 4.3, 4.5, 4.7, 4.9, 5, 5.1, 5.3, 5.5, 5.7, 5.9, 6, 6.1, 6.3, 6.5, 6.7, 6.9, 7, 7.1, 7.3, 7.5, 7.7, 7.9, 8, 8.1, 8.3, 8.5, 8.7, 8.9, 9, 9.1, 9.3, 9.5, 9.7, 9.9, or 10 wt. % aluminum. In another aspect, the alloy for use in at least part of the carbon black air preheater can comprise from about 20 wt. % to about 21 wt. %, for example, about 20, 20.1, 20.2, 20.3, 20.4, 20.5, 20.6, 20.7, 20.8, 20.9, or 21 wt. %; from about 20 wt. % to about 24 wt. %, for example, about 20, 20.2, 20.4, 20.6, 20.8, 21, 21.2, 21.4, 21.6, 21.8, 22, 22.2, 22.4, 22.6, 22.8, 23, 23.2, 23.4, 23.6, 23.8, or 24 wt. %; or from about 18 wt. % to about 28 wt. %, for example, about 18, 18.5, 19, 19.5, 20, 20.5, 21, 21.5, 22, 22.5, 23, 23.5, 24, 24.5, 25, 25.5, 26, 26.5, 27, 27.5, or 28 wt. % chromium. In another aspect, the alloy for use in at least part of the carbon black air preheater can comprise less than about 0.08 wt. %, for example, about 0, 0.01, 0.02, 0.03, 0.04, 0.05, 0.06, or 0.07 wt. %; from about 0 wt. % to about 0.08 wt. %, for example, about 0, 0.01, 0.02, 0.03, 0.04, 0.05, 0.06, 0.07, or 0.08 wt. %; or from about 0 wt. % to about 0.1 wt. %, for example, about 0, 0.01, 0.02, 0.03, 0.04, 0.05, 0.06, 0.07, 0.08, 0.09, or 0.1 wt. % carbon. In other aspects, the alloy for use in at least part of the carbon black air preheater can comprise from about 0.1 wt. % to about 0.7 wt. %, for example, about 0.1, 0.2, 0.3, 0.4, 0.5, 0.6, or 0.7 wt. %; from about 0 wt. % to about 1 wt. %, for example, 0, 0.1, 0.2, 0.3, 0.4, 0.5, 0.6, 0.7, 0.8, 0.9, or 1 wt. %; or from about 0 wt. % to about 3 wt. %, for example, about 0, 0.2, 0.4, 0.6, 0.8, 1, 1.2, 1.4, 1.6, 1.8, 2, 2.2, 2.4, 2.6, 2.8, or 3 wt. % silicon. In still other aspects, the alloy for use in at least part of the carbon black air preheater can comprise from about 0 wt. % to about 0.4 wt. %, for example, about 0, 0.05, 0.1, 0.15, 0.2, 0.25, 0.3, 0.35, or 0.4 wt. % manganese. In other aspects, the alloy for use in at least part of the carbon black air preheater can comprise from about 2 wt. % to about 3 wt. %, for example, about 2, 2.1, 2.2, 2.3, 2.4, 2.5, 2.6, 2.7, 2.8, 2.9, or 3 wt. %; from about 1 wt. % to about 3 wt. %, for example, about 1, 1.2, 1.4, 1.6, 1.8, 2, 2.2, 2.4, 2.6, 2.8, or 3 wt. %; or from about 0 wt. % to about 5 wt. %, for example, about 0, 0.2, 0.4, 0.6, 0.8, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, or 5 wt. % molybdenum. In other aspects, the alloy for use in at least part of the carbon black air preheater can optionally comprise from about 0 wt. % to about 1 wt. %, for example, about 0, 0.1, 0.2, 0.3, 0.4, 0.5, 0.6, 0.7, 0.8, 0.9, or 1 wt. %; from about 0 wt. % to about 20 wt. %, for example, about 0, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 wt. %; or from about 0 wt. % to about 37 wt. %, for example, about 0, 1, 3, 5, 7, 9, 11, 13, 15, 17, 19, 21, 23, 25, 27, 29, 31, 33, 35, or 37 wt. % nickel. In another aspects, the alloy for use in at least part of the carbon black air preheater can optionally comprise from about 0 wt. % to about 1 wt. %, for example, about 0, 0.1, 0.2, 0.3, 0.4, 0.5, 0.6, 0.7, 0.8, 0.9, or 1 wt. %; from about 0 wt. % to about 15 wt. %, for example, about 0, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15 wt. %; or from about 0 wt. % to about 29 wt. %, for example, about 0, 1, 3, 5, 7, 9, 11, 13, 15, 17, 19, 21, 23, 25, 27, or 29 wt. % cobalt. In other aspects, the alloy for use in at least part of the carbon black air preheater can comprise a small amount, for example, less than about 0.1 wt. % of fine ceramic particles. In various aspects, if present, the ceramic particles can comprise oxides such as hafnia, yttria, and/or other suitable particles. While not wishing to be bound by theory, it is believed that the presence of these ceramic particles can pin grain boundaries and reduce creep resistance in the alloy. It should be noted that the alloy of the present disclosure can comprise a smaller or greater concentration of any one or more components recited herein. In other aspects, the alloy can comprise additional components not specifically recited herein, provided that they do not adversely affect the performance of the alloy in use as a carbon black air preheater. The remaining balance of the alloy composition comprises iron.

In one aspect, an alloy for use in a heat exchanger can comprise about 5.8 wt. % aluminum, a chromium level of from about 20.5 wt. % to about 23.5 wt. %, a maximum of about 0.08 wt. % carbon, a maximum of about 0.7 wt. % silicon, a maximum of about 0.4 wt. % manganese, and the remaining balance of iron. In another aspect, the material can comprise about 3 wt. % molybdenum, about 5 wt. % aluminum, a chromium level of from about 20.5 wt. % to about 23.5 wt. % (or about 21 wt. % chromium), a maximum of about 0.08 wt. % carbon, a maximum of about 0.7 wt. % silicon, a maximum of about 0.4 wt. % manganese, and the remaining balance of iron. In another aspect, the material can have a yield strength of from about 450 MPa or about 540 MPa, a tensile strength of about 670 MPa or about 740 MPa, an Elongation of about 27% or about 26%, and/or a hardness of about 225 Hv or about 250 Hv. In another aspect, the material can exhibit a creep strength of about 5.9 MPa at 900° C., about 2 MPa at 1000° C., about 0.7 MPa at 1100° C., or about 0.3 MPa at 1200° C. (based on 1% elongation in 1000 hours). In another aspect, the material can exhibit a creep rupture strength of about 25.3 MPa at 800° C., about 7 or 17.3 MPa at 900° C., about 3.4 or 12.3 MPa at 1000° C., about 1.7 or 6 MPa at 1100° C., or about 2.5 or 1 MPa at 1200° C. (based on 1000 hours). In another aspect, the material can have a density of about 7.1 or about 7.25 g/cm³. In other aspects, a material can comprise any one or more of the properties recited above, and any particular value can be greater than or less than those specifically recited values. It should be understood that the component concentrations and properties recited above are intended to represent those of the native alloy, for example, at the time of construction. After operation and exposure to high temperatures, one or more of these component concentrations and/or properties can change. In one aspect, exposure to high temperatures can result in the formation of an alumina passivating layer on at least a portion of the metal. In another aspect, continued use at lower temperatures can result in the unfavorable formation of chromium oxide at the surface, increased sigma phase, and embrittlement of the alloy.

In one aspect, the purpose of the invention is to increase carbon black reactor air preheater operational temperatures and therefore carbon black production yield via the selection of alloys that are superior to those found in commercially-available state-of-the-art air preheaters.

Current commercially available air preheaters are limited to a maximum air outlet temperature of 950° C., and have poor reliability when operated near this limit. High-temperature corrosion due to the presence of sulfur species in the carbon black process stream results in severe metal corrosion, especially at high operational temperatures. This invention overcomes this problem via the selection of superior performing alloys that exhibit superior corrosion resistance as well as mechanical stability at temperatures where other conventional air preheater alloys fail completely. Aluminum containing alloys, such as the KANTHAL® alloys, are unique in that they contain aluminum within the stainless steel alloy, and this aluminum can act to form an aluminum oxide passivating layer that protects the base metal from attack. Additionally, the incorporation of fine-grained ceramic materials into the alloys confers substantial high-temperature strength and creep resistance via the pinning of the grain boundaries in the alloys.

Thus, in one aspect, a carbon black air preheater can comprise an aluminum containing alloy, such as a KANTHAL® alloy, as described herein. In another aspect, a carbon black air preheater can also comprise an alloy containing aluminum, such that a passivating layer will be formed on the surface of the material during use. In another aspect, a carbon black air preheater can comprise a material having a passivating layer disposed on at least a portion of a surface in contact with a carbon black process stream. In still another aspect, an air preheater can comprise a material containing a fine-grained ceramic material therein that can confer improved strength and creep resistance to the material. In yet another aspect, the air preheater can comprise a surface passivating material or comprise a material that will form a surface passivating layer upon use, and a fine gained ceramic material.

An important feature of this disclosure is the application of such a material in a carbon black air preheater, and in one aspect, in those portions of a carbon black air preheater that are exposed to the highest temperatures during operation. While such materials are commercially available and have advertised performance claims, no data exists on the feasibility of these alloys in a carbon black reactor environment. All of the materials that claim suitability at the desired temperatures are not able to withstand the temperatures and operating conditions of the carbon black manufacturing process. This disclosure is based, in part, on the evaluation and analysis of the materials described herein in a carbon black reactor process stream at temperatures in excess of those typically experienced by a state-of-the-art air preheater.

This invention is advantageous compared to prior carbon black air preheater technology in that the materials described herein, such as, for example, KANTHAL® alloys, have unique high-temperature corrosion resistance that is superior to the heat-resistant alloys that are used in the current state-of-the-art carbon black air preheaters. Current alloys typically exhibit severe corrosion, especially in carbon black reactors that use feedstock oils with high sulfur levels, while the materials described herein have been demonstrated in high-temperature carbon black reactor testing to be entirely resistant or substantially entirely resistant to corrosion in the same conditions. Additionally, these materials have survived exposure to temperatures in a carbon black reactor that exceeded expectations by retaining their shape and resisting corrosion when exposure to temperatures above 1300° C. Based on test results, no alloys used in a state-of-the-art air preheater can survive in that temperature regime for a reasonable period of time.

This invention is novel in the context of its application to carbon black industry and significantly higher operating temperature (e.g., 1,000-1,100° C. air outlet temperature) compared to materials used in commercial state-of-the-art carbon black air preheaters. Testing of various high temperature materials has demonstrated that not all materials described or designed for use at such temperatures are suitable for or will survive the environment of carbon black manufacturing. In one aspect, the use of the materials described herein with carbon black reactor process streams can provide superior performance to conventional air preheater materials.

During testing, these materials exhibited a surprising resistance to corrosion and creep deformation despite being evaluated at temperatures that caused other heat-resistant alloys to fail completely. Lab evaluation of these materials indicated that no internal damage of the bulk metal was observed, meaning that the alloys were highly resistant to sulfidation, carburization, and oxidation. Additionally, minimal creep deformation of the alloys was observed following exposure testing, which is indicative of high creep resistance.

Tube samples prepared from these materials, with embedded thermocouples, have been evaluated multiple times in a carbon black tread reactor at port locations between the first quench and secondary quench (trim) water sprays. The test port location being prior to the final trim water spray has resulted in exposure temperatures that can exceed those typically experienced by a commercial air preheater. The maximum smoke inlet temperature of a 950° C. commercial air preheater is limited to ˜1,050° C., and the exposure testing temperatures of these materials ranged from ˜1,000° C.-1,300° C. depending on reactor process conditions. Simultaneous testing of commercially available conventional alloys used in current air preheaters at the same test locations as the materials described herein resulted in complete failure of those conventional alloys (i.e., the end that was exposed to the reactor was completely corroded away after conclusion of testing).

This invention can be practiced by incorporating the materials described herein into the lower tube assembly of a carbon black air preheater design. The tubes in an air preheater are in direct contact with the hot smoke and gas stream, and raising the inlet temperature would raise the temperature of the bottom section of tubes. In order to make a cost-effective device, the materials described herein, can, in various aspects, be used only where they would be beneficial. In such an aspect, the materials can be installed in the lower section of the tube assembly. In another aspect, all or a portion of an air preheater device can comprise the materials described herein. In one aspect, the length of the tube section comprising the materials described herein can be selected such that the metal temperature of the topmost region of this tube section is at least ˜900° C. in order prevent sigma phase embrittlement of ferritic alloys. A conventional air preheater tube alloy can, for example, then be butt welded to the top of this tube section to make a complete tube assembly. In various aspects, manufacturing the tubes in this manner can reduce total cost by using the materials described herein only where they are needed. In addition to the tube metallurgy changes, modifications to the ceramic refractory installed at the bottom of the air preheater tube sheet and inside of the lower shell section can, in some circumstances, be required to achieve a 1,000° C.-1,100° C. air outlet temperature and/or prevent thermal damage to the shell and tube sheet. In various aspects, the carbon black air preheater described herein can heat air for use in a carbon black manufacturing process to a temperature of at least about 1,000° C., or from about 1,000° C. to about 1,100° C., from about 1,000° C. to about 1,200° C., or from about 1,000° C. to about 1,300° C.

A number of exemplary high temperature metal alloys, as detailed in Table 1, below, were tested in carbon black manufacturing conditions. Despite claims of high temperature use, most of the materials failed the trial in a carbon black manufacturing environment. The Haynes HR160 material partially satisfied the test conditions. Otherwise, the only materials that passed the test conditions were Sandvik APM and APMT materials.

TABLE 1
Alloys Tested in Carbon Black Manufacturing Environment

| | | | Max Continuous |
|---|---|---|---|
| Alloy | Manufacturer | Alloy Components | Use Temp (° C.) |
| HK40 + Nb | Various | Fe, 25% Cr, 20% No, 1% Nb | 1,090 |
| 253MA | Various | Fe, 21% Cr, 11% Ni, 1.7% Si, | 1,093 |
| | | 0.17% N, 0.055% Ce | |
| KANTHAL | Sandvik | Fe, 21% Cr, 3% Mo, 5% Al | 1,250 (temp 1,400) |
| APM ® | (Kanthal Division) | | |
| KANTHAL | Sandvik | Fe, 21% Cr, 5.8% Al | 1,250 (temp 1,400) |
| APMT ® | (Kanthal Division) | | |
| KHRSA | Kubota Materials Canada | 31% Cr, 51% Ni, 14% W | 1,204 |
| UCX | Kubota Materials Canada | 43% Cr, 50% Ni, 2.5% Si | 1,204 |
| SUPERTHERM ® | Duraloy | Fe, 25% Cr, 35% Ni, 15% Co, | 1,260 |
| | | 5% W | |
| 214 | Haynes | 75% Ni, 16% Cr, 4.5% Al, | 1,315 |
| | | 3% Fe | |
| HR160 | Haynes | 37% Ni, 29% Co, 28% Cr, | 1,204 |
| | | 2.75% Si, 2% Fe | |

In another aspect, the carbon black air preheater can comprise any design suitable for use in a carbon black reactor. In a specific exemplary aspect, the carbon black air preheater comprises a plurality of spaced apart tubes arranged in a parallel manner and encased in an external shell. One of skill in the art in the carbon black industry could readily design an air preheater for a carbon black manufacturing unit using the materials described herein.

The present invention also provides a carbon black manufacturing process, wherein the carbon black air preheater described herein is a part of the process, for example, in fluid communication with and/or downstream of the carbon black furnace or reactor.

In addition to the aspects described herein and in the drawings, the present invention can also be described in one or more of the following non-limiting aspects.

Aspect 1: A carbon black air preheater, wherein at least a portion of the carbon black air preheater comprises an alloy comprising from about 3 wt. % to about 10 wt. % aluminum, from about 18 wt. % to about 28 wt. % chromium, from about 0 wt. % to about 0.1 wt. % carbon, from about 0 wt. % to about 3 wt. % silicon, from about 0 wt. % to about 0.4 wt. % manganese, from about 0 wt. % to about 0.5 wt. % molybdenum, and a remaining balance of iron.

Aspect 2: The carbon black air preheater of Aspect 1, wherein the alloy further comprises from about 0 wt. % to about 37 wt. % nickel, from about 0 wt. % to about 29 wt. % cobalt.

Aspect 3: The carbon black air preheater of Aspect 1, wherein the alloy comprises from about 5 wt. % to about 6 wt. % aluminum, from about 20 wt. % to about 21 wt. % chromium, from about 0 wt. % to about 0.08 wt. % carbon, from about 0.1 wt. % to about 0.7 wt. % silicon, from about 0 wt. % to about 0.4 wt. % manganese, from about 2 wt. % to about 3 wt. % molybdenum, from about 0 wt. % to about 1 wt. % nickel, from about 0 wt. % to about 1 wt. % cobalt, and a remaining balance of iron.

Aspect 4: The carbon black air preheater of Aspect 1, wherein the alloy comprises from about 5 wt. % to about 6 wt. % aluminum, from about 20.5 wt. % to about 23.5 wt. % chromium, less than about 0.08 wt. % carbon, less than about 0.7 wt. % silicon, less than about 0.4 wt. % manganese, about 3 wt. % molybdenum, and a remaining balance of iron.

Aspect 5: The carbon black air preheater of Aspect 1, wherein the alloy forms a surface passivating layer on at least a portion of the alloy upon sustained exposure to a carbon black manufacturing environment.

Aspect 6: The carbon black air preheater of Aspect 1, wherein the alloy forms a surface alumina layer on at least a portion of the alloy upon exposure to a carbon black manufacturing environment.

Aspect 7: The carbon black air preheater of Aspect 1, wherein the alloy further comprises a plurality of ceramic particles disposed within the alloy.

Aspect 8: The carbon black air preheater of Aspect 1, wherein the carbon black air preheater is a counter flow energy recovery heat exchanger.

Aspect 9: The carbon black air preheater of Aspect 1, wherein the at least a portion of the carbon black air preheater comprises all or a portion of a plurality of tubes disposed within the carbon black air preheater.

Aspect 10: The carbon black air preheater of Aspect 1, wherein the at least a portion of the carbon black air preheater comprises a portion of one or more tubes disposed within the carbon black air preheater, wherein the portion of one or more tubes is located at a first end of the one or more tubes in fluid communication with a carbon black furnace.

Aspect 11: The carbon black air preheater of Aspect 1, wherein the carbon black air preheater is a part of a carbon black manufacturing process.

Aspect 12: The carbon black air preheater of Aspect 11, wherein the carbon black air preheater is in fluid communication with a carbon black furnace.

Aspect 13: The carbon black air preheater of Aspect 1, being capable of heating air to a temperature of at least about 1,000° C. for a sustained period of time.

Aspect 14: The carbon black air preheater of Aspect 1, being capable of heating air to a temperature of at least about 1,000° C. for a sustained period of time without significant degradation.

Aspect 15: The carbon black air preheater of Aspect 1, being capable of heating air to a temperature of from about 1,000° C. to about 1,300° C.

Aspect 16: A carbon black manufacturing process comprising a carbon black furnace and a carbon black air preheater positioned downstream of and in fluid communication with the carbon black furnace, wherein the carbon black air preheater comprises an alloy comprising from about 3 wt. % to about 10 wt. % aluminum, from about 18 wt. % to about 28 wt. % chromium, from about 0 wt. % to about 0.1 wt. % carbon, from about 0 wt. % to about 3 wt. % silicon, from about 0 wt. % to about 0.4 wt. % manganese, from about 0 wt. % to about 0.5 wt. % molybdenum, and a remaining balance of iron.

Aspect 17: The carbon black manufacturing process of Aspect 16, wherein the alloy further comprises from about 0 wt. % to about 37 wt. % nickel, from about 0 wt. % to about 29 wt. % cobalt.

Aspect 18: The carbon black manufacturing process of Aspect 16, wherein the carbon black air preheater comprises an alloy comprising from about 5 wt. % to about 6 wt. % aluminum, from about 20 wt. % to about 21 wt. % chromium, from about 0 wt. % to about 0.08 wt. % carbon, from about 0.1 wt. % to about 0.7 wt. % silicon, from about 0 wt. % to about 0.4 wt. % manganese, from about 0 wt. % to about 3 wt. % molybdenum, from about 0 wt. % to about 37 wt. % nickel, from about 0 wt. % to about 29 wt. % cobalt, and a remaining balance of iron.

Aspect 19: The carbon black manufacturing process of Aspect 16, wherein the alloy forms a surface passivating layer on at least a portion of the alloy upon sustained exposure to a carbon black manufacturing environment.

Aspect 20: The carbon black manufacturing process of Aspect 16, wherein the alloy forms an alumina layer on at least a portion of the alloy upon exposure to a carbon black manufacturing environment.

Aspect 21: The carbon black manufacturing process of Aspect 16, wherein the alloy further comprises a plurality of ceramic particles disposed within the alloy.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A carbon black air preheater, wherein at least a portion of the carbon black air preheater comprises an alloy comprising from about 3 wt. % to about 10 wt. % aluminum, from about 18 wt. % to about 28 wt. % chromium, from about 0 wt. % to about 0.1 wt. % carbon, from about 0 wt. % to about 3 wt. % silicon, from about 0 wt. % to about 0.4 wt. % manganese, from about 0 wt. % to about 0.5 wt. % molybdenum, and a remaining balance of iron.

2. The carbon black air preheater of claim 1, wherein the alloy further comprises from about 0 wt. % to about 37 wt. % nickel, from about 0 wt. % to about 29 wt. % cobalt.

3. The carbon black air preheater of claim 1, wherein the alloy comprises from about 5 wt. % to about 6 wt. % aluminum, from about 20 wt. % to about 21 wt. % chromium, from about 0 wt. % to about 0.08 wt. % carbon, from about 0.1 wt. % to about 0.7 wt. % silicon, from about 0 wt. % to about 0.4 wt. % manganese, from about 0 wt. % to about 3 wt. % molybdenum, from about 0 wt. % to about 1 wt. % nickel, from about 0 wt. % to about 1 wt. % cobalt, and a remaining balance of iron.

4. The carbon black air preheater of claim 1, wherein the alloy comprises from about 5 wt. % to about 6 wt. % aluminum, from about 20.5 wt. % to about 23.5 wt. % chromium, less than about 0.08 wt. % carbon, less than about 0.7 wt. % silicon, less than about 0.4 wt. % manganese, about 3 wt. % molybdenum, and a remaining balance of iron.

5. The carbon black air preheater of claim 1, wherein the alloy forms a surface passivating layer on at least a portion of the alloy upon sustained exposure to a carbon black manufacturing environment.

6. The carbon black air preheater of claim 1, wherein the alloy forms a surface alumina layer on at least a portion of the alloy upon exposure to a carbon black manufacturing environment.

7. The carbon black air preheater of claim 1, wherein the alloy further comprises a plurality of ceramic particles disposed within the alloy.

8. The carbon black air preheater of claim 1, wherein the carbon black air preheater is a counter flow energy recovery heat exchanger.

9. The carbon black air preheater of claim 1, wherein the at least a portion of the carbon black air preheater comprises all or a portion of a plurality of tubes disposed within the carbon black air preheater.

10. The carbon black air preheater of claim 1, wherein the at least a portion of the carbon black air preheater comprises a portion of one or more tubes disposed within the carbon black air preheater, wherein the portion of one or more tubes is located at a first end of the one or more tubes in fluid communication with a carbon black furnace.

11. The carbon black air preheater of claim 1, wherein the carbon black air preheater is a part of a carbon black manufacturing process.

12. The carbon black air preheater of claim 11, wherein the carbon black air preheater is in fluid communication with a carbon black furnace.

13. The carbon black air preheater of claim 1, being capable of heating air to a temperature of at least about 1,000° C. for a sustained period of time.

14. The carbon black air preheater of claim 1, being capable of heating air to a temperature of at least about 1,000° C. for a sustained period of time without significant degradation.

15. The carbon black air preheater of claim 1, being capable of heating air to a temperature of from about 1,000° C. to about 1,300° C.

16. A carbon black manufacturing process comprising a carbon black furnace and a carbon black air preheater positioned downstream of and in fluid communication with the carbon black furnace, wherein the carbon black air preheater comprises an alloy comprising from about 3 wt. % to about 10 wt. % aluminum, from about 18 wt. % to about 28 wt. % chromium, from about 0 wt. % to about 0.1 wt. % carbon, from about 0 wt. % to about 3 wt. % silicon, from about 0 wt. % to about 0.4 wt. % manganese, from about 0 wt. % to about 0.5 wt. % molybdenum, and a remaining balance of iron.

17. The carbon black manufacturing process of claim 16, wherein the alloy further comprises from about 0 wt. % to about 37 wt. % nickel, from about 0 wt. % to about 29 wt. % cobalt.

18. The carbon black manufacturing process of claim 16, wherein the carbon black air preheater comprises an alloy comprising from about 5 wt. % to about 6 wt. % aluminum, from about 20 wt. % to about 21 wt. % chromium, from about 0 wt. % to about 0.08 wt. % carbon, from about 0.1 wt. % to about 0.7 wt. % silicon, from about 0 wt. % to about 0.4 wt. % manganese, from about 0 wt. % to about 3 wt. % molybdenum, from about 0 wt. % to about 37 wt. % nickel, from about 0 wt. % to about 29 wt. % cobalt, and a remaining balance of iron.

19. The carbon black manufacturing process of claim 16, wherein the alloy forms a surface passivating layer on at least a portion of the alloy upon sustained exposure to a carbon black manufacturing environment.

20. The carbon black manufacturing process of claim 16, wherein the alloy forms an alumina layer on at least a portion of the alloy upon exposure to a carbon black manufacturing environment.

21. The carbon black manufacturing process of claim 16, wherein the alloy further comprises a plurality of ceramic particles disposed within the alloy.
